(19) United States
(12) Patent Application Publication
(10) Pub. No.: US 2017/0212979 A1
(43) Pub. Date: Jul. 27, 2017

(54) Method for quickly full-scale analyzing and designing the processing parameters and deposit strategy on temperature field for 3D printing/Additive manufacturing

(71) Applicant: Jinquan Cheng, Chandler, AZ (US)

(72) Inventor: Jinquan Cheng, Chandler, AZ (US)

(21) Appl. No.: 14/921,640

(22) Filed: Oct. 23, 2015

(51) Int. Cl. G06F 17/50; B33Y 50/00

(52) U.S. Cl. CPC G06F 17/5086; B33Y 50/00

(57) ABSTRACT

A method of modelling and simulating the full-scale temperature distribution, temperature gradient and cooling rate for 3D printing (additive manufacturing) a part or multi-parts throughout the additive manufacturing procedure on the basis of layerwise block technique is disclosed and claimed. The method enables to model the deposition part(s) with the various profiles as multi-different blocks by introducing the multi-blocks model and then reduce the 3D simulation problem to a 2D simulation problem by laminated block approach. Thus, the method can reduce the computational work and realize the quick simulation and analysis of the effect of processing parameters and deposit strategy on the full-scale temperature distribution, temperature gradient and cooling rate in the additive manufacturing deposition track-by-track and layer-by-layer, further help people to design the processing parameters and deposit strategy through full-scale temperature field change.

### FIELD OF THE INVENTION

The present invention broadly relates to a method for modeling and simulating the full-scale temperature, temperature gradient and cooling rate throughout the procedure of additive manufacturing technique for processing metal or polymer part(s) with arbitrary profile(s), and more particularly to a method for creating a layerwise block model to realize the quick full-scale analysis and simulation for additive manufacturing for the different processing parameters, deposition patterns and different part profiles. This invention includes how to create the blocks for the part/parts with the different profile/profiles and how to reduce the computation works through the profile(s) transfer and dimensional reduction, and create the simulation tools to simulate it. Based on the invention, a software also has been implemented by C++ program language, named as layerwise additive manufacturing predictions and simulations (LAMPS).

### BACKGROUND OF THE INVENTION

It is well-known that the general additive manufacturing is a procedure of line-by-line and layer-by-layer directly depositing the host materials by a heat source, such as laser or electron beam, to fabricate the final desired part from a digital design file. Thus, the procedure is a problem of a complex heat transfer with phase change [2]. However, the procedure involves more than 50 factors having a certain effect on the temperature distribution, temperature gradient and cooling rate in the Additive manufacturing part from the environment, the deposition material properties, the powder granulometry and deposition, the powder bed properties, the heat source properties and qualities and the processing parameters as shown in Table 1 [3]. For examples, as revealed by the experiments, the oxygen percentage in the deposition chamber has a significant effect on the surface tension of the melt pool and results in different microstructure solidifications [4]; For the powder bed thermos-physical properties, it is evident that the loose powder's heat conductivity is much lower than the bulky material, which results in the localized temperature gradient change [5]; For the deposition location effect, it is clearly shown from the x-ray experimental results that there are over 70% defects occurred nearby the free-surface[6].

Even though there are lots of experiments have studied the individual factor effect on the part quality respectively, it is still difficult to outline a feasible processing parameter set to get a high quality as-deposited part since so many factors involving the processes make the extreme complexity of heat transfer problem in Additive Manufacturing, as indicated in Table 1. Thus, lots of numerical tools/softwares have been developed to analyze the Additive Manufacturing procedure. However, since the thickness of the depositing layer could be from serval micrometers to hundred micrometers, one Additive Manufacturing part generally needs thousands of such a layer to be deposited. Thus, it becomes very difficult to use element-based numerical tools to emulate the whole additive manufacturing procedure in the track-by-track and layer-by-layer due to the limitation of the element-size and element-number in the current available simulation tools. Therefore, how to envision the effect of those processing parameters on the microstructure evolution and further predict/determine the whole part quality becomes an impossible mission. Based on the conventional finite element model, a general deposition with over 10 thousands track/line deposition will take several years. Stucker presented some detailed discussion about the time and computational efficiency comparison for simulating powder bed sample with 200 mm×200 mm×200 mm bed size and indicated that for ANSYS with multi-scale the computation time will be 89 billion years [7]. It is ridicule from the design viewpoint. But, it is more and more demanded in the additive manufacturing industries. Based on the additive manufacturing characteristics of line-by-line and layer-by-layer deposition to form the final part(s), a layerwise model from composite material can be extended to simplify the simulation. In order to consider the material difference between the different regions due to deposition or melting and solidification, a multi-blocks model is invented to simplify the simulation work. Furthermore, the computation work can be reduced from a 3D problem to a 2D one by the aid of laminated plate/shell theory and developed multi-blocks method. Thus, the total computational work can be dramatically reduced.

Based on the invention, layerwise additive manufacturing predictions and simulations (L.A.M.P.S.) software was developed by C++ object orientation language to predict and simulate the whole additive manufacturing procedure from the line-by-line and layer-by-layer to the final part/parts. In the current version (version 1.), the LAMPS software can predict and analyze the effect of the key processing parameters, including scan speed, input energy, deposition location and deposit pattern etc., deposition material properties, baseplate material properties and geometries etc. on the distribution of the temperature and temperature gradient, cooling rate in the whole part without the simulation size limitation during the depositing.

TABLE 1
List of the effect factors on the part quality in Additive Manufacturing

| Sources | Effect Factors |
|---|---|
| Environments | Inert gas, Molecular mass, Viscosity, Thermal conductivity, Heat exchange |
| | coefficient of convection, Thermal capacity, Pressure, Oxygen level % O2, |
| | Ambient temperature, Surface free energy. |
| Powder | Bulk density, Thermal conductivity, Thermal capacity, Latent heat of fusion, |
| composition: | Melting temperature, Boiling temperature, Dynamic viscosity, Thermal |
| material | expansion coefficient, Surface free energy, Vapor pressure, Reaction energy, |
| | Absorptivity, Diffusion coefficient, Solubility, Melt enthalpy, Pollution |
| Powder | Morphology, Surface roughness, Particle size distribution, Depositioning |
| granulometry | system |
| and deposition | |
| Powder bed | Density, Conductivity, Absorptivity, Emissivity, Diffusivity, |
| properties | |
| Laser based | Mode, Wave length, Intensity profile, Average power, Peak power, Beam |
| heat source | quality, Frequency, Pulse width, Spot size dx & dy, Polarity |
| Processing | Scan Strategy, Scan spacing, Scan speed, Energy Density, Layer thickness, |
| parameters | 3D environment |

### SUMMARY OF THE INVENTION

The present invention contemplates a model for modelling and simulating the full-scale temperature distribution, temperature gradient and cooling rate for the additive manufacturing part during the additive manufacturing deposition. The model comprises the complicate structure of the deposition part(s) and the deposition materials. For the complicate structure, the more blocks are introduced to accurately represent the structure. And, the rule to create a block for a deposition part is that for a layer within a block, it consists of only one type of material with the same properties: anisotropic or isotropic. But one layer's material can be different from the other layer within a block.

The present invention contemplates methods of quickly simulating the full-scale temperature distribution, temperature gradient and cooling rate for the additive manufacturing part during the additive manufacturing deposition. The methods comprise the multi-block method and laminated block method .i.e. the multi-block method to partition the deposition part(s) into multi-blocks and laminated block method to reduce the 3D problem into a 2D problem and further simplify the computational work for the additive manufacturing. After the laminated block method applied, the simulation of the total conductivity matrix for the whole additive manufacturing part become much simple. This can enhance the computation efficiency in simulating the temperature, temperature gradient and cooling rate during the additive manufacturing processing.

The present invention also contemplates methods of predicting the processing parameters effect on the temperature distribution, temperature gradient and cooling rate for the whole additive manufacturing deposition procedure track-by-track and layer-by-layer.

The present invention also contemplates methods of predicting the effect of the both processing parameters and deposition strategy on the temperature distribution, temperature gradient and cooling rate for the whole additive manufacturing deposition procedure track-by-track and layer-by-layer, including the key parameters: scan speed, power input, beam diameter, powder feed rate, powder bed thickness, powder bed densification, base plate and part geometry, base plate materials properties and deposition material properties, etc.

In addition, the present invention also provides some detailed methods of creating the multi-block for the deposition part with the different profile/shape. As mentioned above, the method of creating the multi-blocks for a part is not only for the simple deposition part but also for the more complicate part based on the rule for multi-block creation.

The invention also provides a method to read the processing parameters and deposition path/strategy into the model and do the simulation. Thus, the developed software LAMPS can analyze the deposition strategy effect on the full-scale temperature changes during the deposition.

Furthermore, based on the invention, a software named Layerwise Additive Manufacturing Predictions and Simulations (L.A.M.P.S.) have been developed to verify the developed methods and validate the simulation performance. It can achieve much fast simulation with comparison to FEM method. The model can be parametrically exercised using the developed LAMPS. This can include the scan speed, power input, beam diameter, powder feed rate, powder bed thickness, powder bed densification, base plate and part geometry, base plate materials properties and deposition material properties in current version 1.0 LAMPS software. Finally, the effects of these parametric manipulations on deposited part residual stress and distortion characteristics can be investigated.

### BRIEF DESCRIPTION OF THE DRAWINGS

The following drawings are merely examples of possible constructions for block construction for full-scale modelling and simulating the processing parameters, geometry, deposit strategy etc. effect on the temperature, temperature gradient and cooling rate throughout the additive manufacturing procedure for any materials:

FIG. 1 illustrates an additive manufacturing part by cladding or powder-bed technique in the different locations: (a) central location (b) bias location. For the cladding technique, the media around the building part is air or special gas for special deposition requirement. For the powder bed processing, the media around the building part is the powder for melting. Thus the thermal properties such as conductivity will be quite different from the bulky materials.

FIG. 2 presents a simplest block formation for additive manufacturing a square part at different locations from the top-view: (a) central location, (b) bias location. (The black dots are the key nodes for the blocks).

FIG. 3 illustrates the details of 5-blocks model for the partitioned 5 independent blocks.

FIG. 4 shows a sample of the block constructions for additive manufacturing a diamond shape part at bias location from top view: (a) 5-blocks construction, and (b) 12-blocks construction.

FIG. 5 illustrates the construction of a five blocks model for simulating the additive manufacturing a blade shape part from the top-view: (a) 5-block construction (b) 8-block construction

FIG. 6 illustrates the construction of a five blocks model for simulation of additive manufacturing a part with an arbitrary profile.

FIG. 7 illustrate the deposition part with an arbitrary profile and an arbitrary open hole: (a) deposition part with a blade-shape; (b) deposition part with arbitrary shape.

FIG. 8 presents the deposition part with an arbitrary profile and two arbitrary open holes

FIG. 9 illustrates the deposition part with an arbitrary profile and an arbitrary open hole: (a) deposition part with blade-shape (b) deposition part with arbitrary shape and an open hole

FIG. 10 illustrates of a deposition part having the different cross-sections in the different location: (a) a deposition part geometry, (2) two sections of the deposition part, (3) additive manufacturing the part.

FIG. 11 illustrates a simplest multi-blocks creation for a deposition part with 2 different cross-sections.

FIG. 12 illustrates the block creation method for a deposition part with 3 different cross-sections: (a) three sections with the different cross-section area; (b) Section 3's cross-section same to Section 1's cross-section but different from Section 2; (c) Section 1's cross-section larger than Section 3; (d) Section 1's cross-section less than Section 3.

FIG. 13 illustrates the block creation for a deposition part with 3 different cross-sections (a) middle section 2 is largest one with hole and Section 1 and 3 are same. (b): a 13-block model for the cases.

FIG. 14 illustrates the multi-blocks creation for a deposition part with 3 different cross-sections (a) Section 1 has largest cross-section and Section 2 has a hole with the mode and Section 1 and 3 are same. (b): a 13-block model for the cases.

FIG. 15 illustrates the multi-blocks creation for a solid deposition part with 3 different cross-sections (a): a simplest 9-block model for FIG. 12(b). (b): a simplest 13-block model for the case in FIG. 13(b).

FIG. 16 illustrates a sample of the multi-block model for a deposition part with complicate geometry (There are total 17 blocks with 19 key-nodes.): (a) 3-section part, (b) additive manufacturing, and (c) multi-blocks model.

FIG. 17 illustrates a sample of creating the multi-blocks model for a deposition part over an irregular deposition: (a) additive manufacturing part over an irregular baseplate; (b) a simplest 5-blocks model creation for the deposition case.

FIG. 18 illustrates the multi-block model for the additive manufacturing based repairing problem: (a) base part and deposition part; (b) top view of the total part; (c) additive manufacturing for the part; (d) the multi-block model for the part.

FIG. 19 illustrates how to convert the irregular shape to a regular shape for reducing the computation work.

FIG. 20 illustrates how to convert the irregular triangle shape to a regular shape for reducing the computation work.

FIG. 21 illustrates the construction of the computational sub-domains and the interfacial lines between two adjacent blocks.

FIG. 22 illustrates the GUI for the Layerwise Additive Manufacturing Predictions and

Simulations (L.A.M.P.S.) software based on the developed method.

FIG. 23 schematically show the layerwise additive manufacturing model based on the characteristics of the additive manufacturing track-by-track and layer-by-layer procedure

FIG. 24 shows the flow chart for LAMPS software based on the developed laminated block method for simulating the full scale temperature, temperature gradient and cooling rate for the additive manufacturing processing.

### REFERENCE

1. J. N. Reddy, Mechanics of laminated plate and shell: theory and analysis, CRC press LLC, Washington D.C., 2004.
2. Mani Mahesh, Feng Shaw, Lane Brandon, Donmez, Moylon Shawn, Ronnie Fesperman, Measurement Science needs for real-time control of additive Manufacturing powder bed fusion processes, NISTIR8036, 2015.
3. Van Elsen Maarten, Complexity of selective laser melting: a new optimization approach, Ph.D. dissertation, Katholieke Universiteit LEUVEN, Belgium, 2007.
4. Zhao C X, Kwakernaak C., Pan Y., Richardson I. M, Saldi Z, Kenjeres S., Kleijn, C R. The effect of oxygen on transitional Marangoni flow in laser spot welding, Acta Materialia, 58: 6345-6357, 2010.
5. Shen N G, Chou K, numerical thermal analysis in electron beam additive manufacturing with preheat effects, MS&T 2013, Montreal, Canada, Oct. 27-Oct. 30, 2013.
6. Leonard F., Tammas-williams S., Prangnell P B, Todd I., Withers P J., Assessment by X-ray CT of the effects of geometry and build direction on defects in Titanium ALM part, MS&T 2013, Montreal, Canada, Oct. 27-Oct. 30, 2013.
7. Brent Stucker, Recent trends in additive manufacturing & the need for predictive Simulation, Additive Work conference, 2015.
8. Bath, K. J. (1996). Finite Element Procedures, Prentice-Hall, Englewood Cliffs, N.J.
9. Guan Yuanxian, Li Haimei, Variatioal principle and numerical computing for phase change heat transfer with material boundary concept. Acta Mechanica Solida Sinica, 21(3) :261-266, 2000.
10. Finlayson B A, Variational principles of heat transfer, Numerical properties and methodologies in heat transfer, Proceeding of the Second National Symposium, edited by Shih T M, 1993.
11. Noack J, Eine schichtweise theorie and numeric fur warmeleitung in hybridstrukturen, dissertation, shaker Verleg Aachen, 2000.
12. Jinquan Cheng, optimization of processing parameters for additive manufacturing by analytical layerwise model, MS&T 2015, Oct. 4-8, 2015, Page 1-8, Columbus, Ohio, USA.
13. Jinquan Cheng, power-point presentation for optimization of processing parameters for additive manufacturing by analytical layerwise model, MS&T 2015, Oct. 4-8, Columbus, Ohio, USA.

1. A method of reading the deposition information from the pre-designed processing parameters and deposition path files, such as the deposition scanning speed, input power, base plate property and geometry, deposition material(s) and its (their) material properties, deposition strategy/path etc. information.
(i) Determining the deposition section profile and deposition material(s) for each deposition layer.
(ii) Transforming the deposition section information into additive manufacturing simulation language and for the next step block partition.

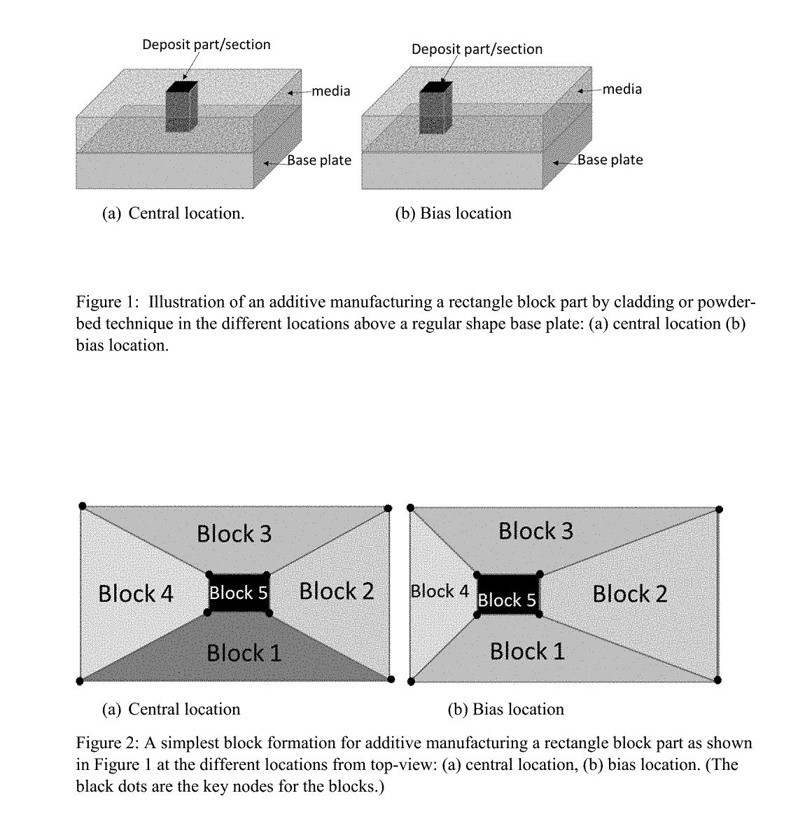

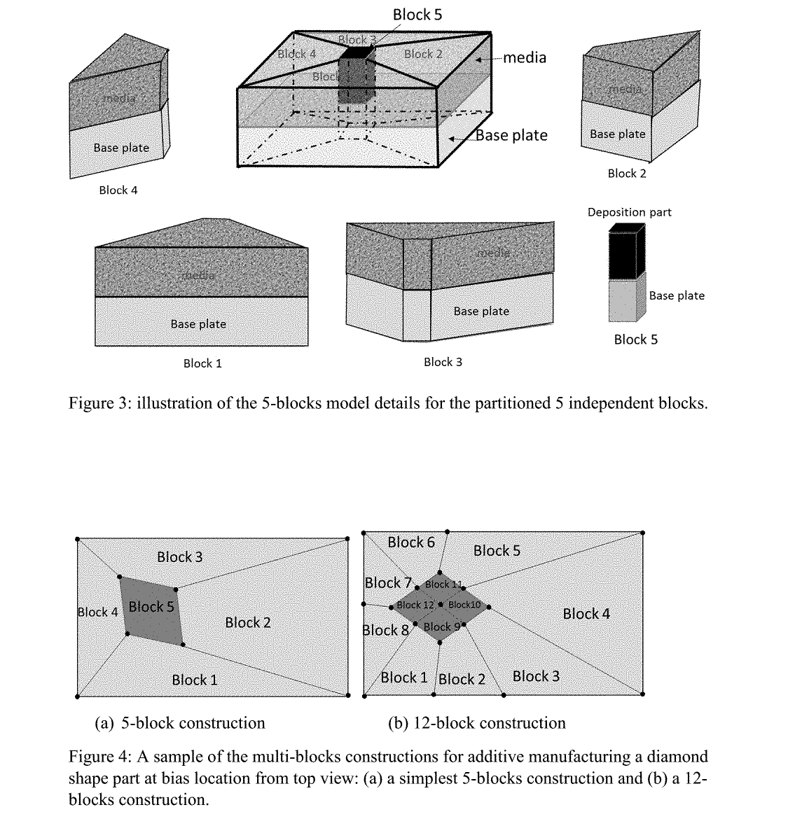

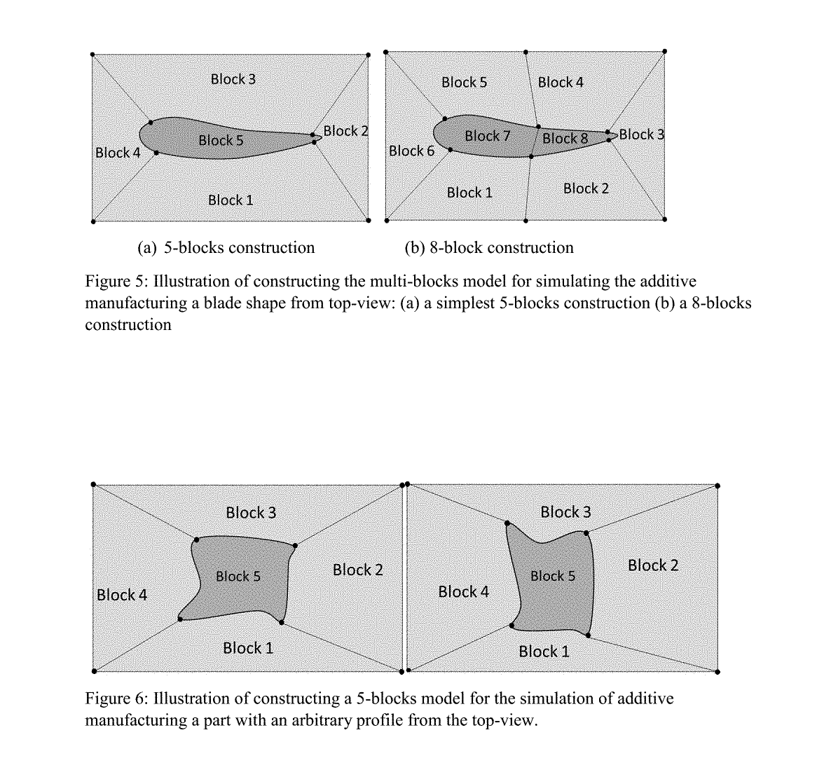

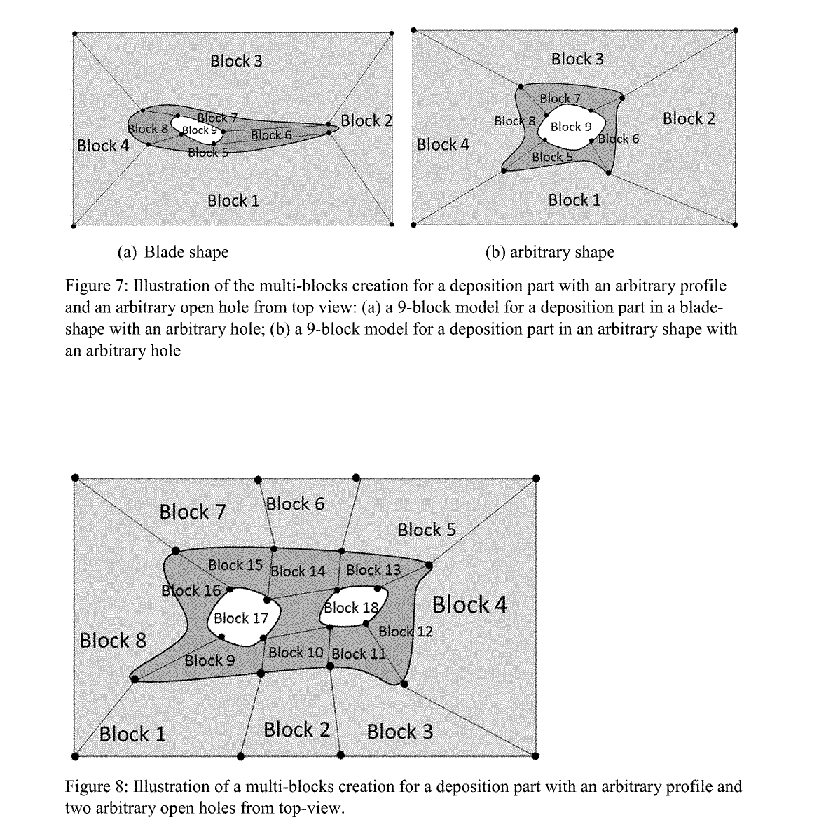

2. A method to create the different blocks based on the deposition part profile with same cross-section in each deposition layer over a regular base plate and form the multi-simulation domains laminated with same or different materials. There are some samples for constructing the multi-blocks for a deposition part over a regular part.
(i) Creating a simplest multi-blocks model for a deposition part with same cross-section from first deposition layer to last deposition layer. FIG. 1 illustrates a sample of only additively manufacturing one square part by powder-bed or cladding method. The deposition is deposited over a base plate. The deposition part can be located in any location over the base plate. For the power-bed method, the media over the base plate should be the powder. For the cladding method, it should be a gas media, such as air or nitrogen etc. The method does not matter what the media is but only same media in a layer within a block. FIG. 2 displays the block construction for the sample shown in FIG. 1. It consists of the simplest five blocks with the 8 key nodes which are the back dot in FIG. 2 used to create a block. Thus, any created block has four key nodes, which are independent or shared with the other adjacent blocks. Block 1 to Block 4 are the media with covered base plate section, powder or gas, and Block 5 is the deposition section with covered base plate section. FIG. 3 displays the partitioned five blocks independently.
(ii) Creating the complex blocks for one deposition part with same cross-section in a regular shape/profile from the first deposition layer to the last deposition layer. FIG. 4 illustrates a sample of a diamond shape deposit part and its block formations, FIG. 4(a) for 5 blocks construction and FIG. 4(b) for 12 blocks construction. For a five block structure, the four blocks are constructed outside the deposition part and one block inside the deposition part. For a 12-blocks model, it will be 8 blocks outside the deposition part and 4 block inside the deposition part.
(iii) Creating the complex blocks for one deposition part with same cross-section in an irregular shape/profile from the first deposition layer to last deposition layer. FIG. 5 displays the block construction of the simplest block model for a blade shape additive manufacturing by a 5-blocks formation and a complicate 8-blocks model. For the simplest 5-blocks construction, the deposition blade only contains one block, i.e. Block 5, and the other 4 blocks are outside the deposition part, as shown in FIG. 5(a). For an 8-blocks formation, there are 2 blocks inside the deposition part and 6 blocks outside the deposition part as shown in FIG. 5(b).
(iv) Creating the complex blocks for a deposition part with an arbitrary profile. FIG. 6 shows the sample of the simplest 5-blocks construction of a deposition part with arbitrary profile at different locations. There is only one block for the deposition part, i.e. Block 5, and the other 4 blocks outside the deposition part.
(v) Creating the complex blocks for a deposition part with one hole or more one open holes (i.e. multi holes). FIG. 7(a) shows the sample of a simplest 9-blocks construction for a blade-shape deposition with an arbitrary hole. Block 9 is for the hole inside the deposition part, Block 5 to Block 8 are constructed for the deposition part and Block 1 to Block 4 are outside the deposition part. FIG. 7(b) shows the sample of a simplest 9-blocks construction for an arbitrary-shape deposition with an arbitrary hole. FIG. 8 displays an 18-block construction for a deposition part with 2 holes. Block 1 to Block 8 are outside the deposition part. The deposition part contains the Block 9 to Block 16. Block 17 and Block 18 represent the holes inside the deposition part.
(vi) The block creation can be used to construct the blocks for the deposition part and the base plate with any type of profiles. The constructed blocks' number strongly depends on the deposition part shape and base plate shape. Thus, it will be different case by case. The block number constructed for a deposition part with a complex profile will require more blocks. However, the rule of creating the block model is that the material in a deposition layer must be same within a block; the faster the simulation, the less the blocks. Any blocks must include four key nodes to form the block four lines which must have three non-collinear lines. And furthermore the created block shape can be exactly or approximately mapping from the physical coordinate to the computation domain, for examples, by a quadratic serendipity shape function or a cubic serendipity shape function.

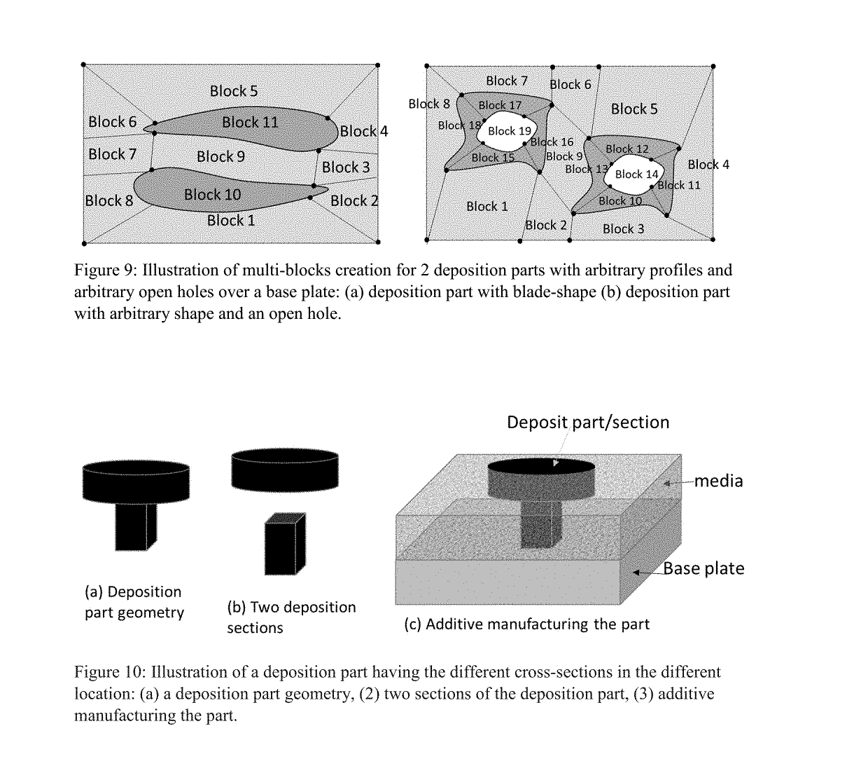

3. A method to create the multi-blocks for a simultaneous multi-deposition independent parts over a base plate.
(i) The method is an extension from claim 2 to create the multi-blocks model for simultaneous multi-deposition parts over a base plate.
(ii) Creating the multi-blocks for 2 deposition parts depositing over a base plate by following the rule of multi-blocks creation claimed in claim 2(VI) as shown in FIG. 9. FIG. 9(a) is for two blade-shape deposition parts over a base plate. It consists of 11 blocks, Block 1 to Block 9 are located outside the deposition parts and Block 10 is for the deposition Part No. 1 and Block 11 for the deposition Part No. 2. FIG. 9(b) is for two deposition parts with arbitrary shapes and open holes over a base plate. Based on the block construction rule, it consists of 19 blocks. Block 1 to Block 9 are outside the deposition parts, Block 10 to Block 13 are for the deposit Part No. 1, Block 14 is for the hole inside the Part No. 1, Block 15 to Block 18 are for the deposition Part No. 2, Block 19 is for the hole inside the deposition Part No. 2.
(iii) The rule for creating the multi-blocks model for a simultaneous multi-deposition independent parts over a base plate is following the rule claimed in claim 2(vi). Noted that the less the created blocks, the faster the simulation.
(iv) For the cases of more than two parts deposited over a base plate, it will follow the rule claimed in claim 3 (iii) to create the multi-blocks model for the simulation. The less the blocks number, the less the computation work.

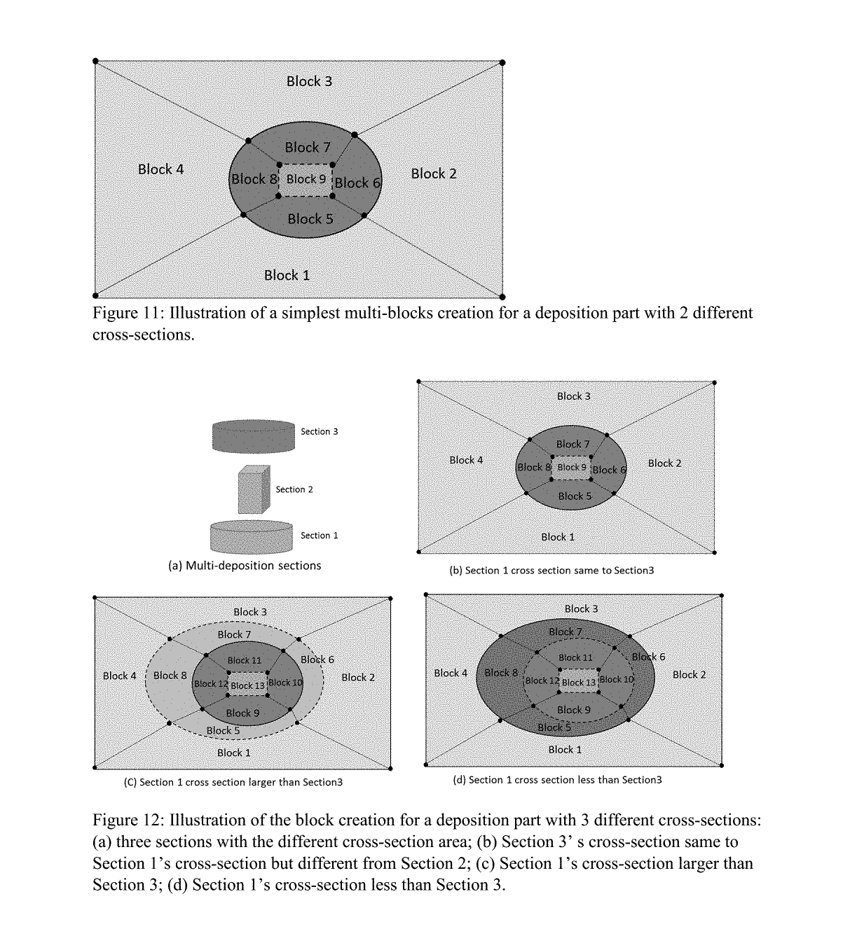

4. A method to create the multi-blocks for the deposition part with two different cross-sections from some layers to the other some layers over a regular baseplate.
(i) This method is utilized to create the multi-blocks for the deposition part with two different cross-sections by following the block construction rule claimed in claim 2(vi) While the cross section is different from some layers deposition to the other some layers, the new blocks need construct in the difference region between these two different deposition profiles. See claim 4(ii) for a sample.
(ii) Creating the multi-blocks for the different deposition profile following the rule claimed in claim 2(vi). FIG. 10 presents a sample to create a multi-blocks model for a deposition part with the different deposition profiles. It has a rectangle shape deposition and then a cylinder shape deposition over the rectangle. FIG. 10(a) shows the two deposition cross-sections with the rectangle cross-section and circular cross-section in the different deposition layers. FIG. 10(b) presents the separated two sections of the deposition part. FIG. 10(c) shows the additive manufacturing the deposition part with the different cross-section profiles. FIG. 11 shows the sample of multi-blocks creation for such a kind deposition from the top view. There are total 9-blocks model for the sample shown in FIG. 11. Block 1 to Block 4 are created outside the deposition part. Block 5 to Block 9 are inside the deposition part. And Block 9 is the same shape/profile to the rectangle cross-section profile.
(iii) The rule to create the multi-blocks model for a deposition part with different cross-sections still follows the rule claimed in claim 2(vi). To create the multi-blocks for a deposition part with different cross-sections, the material must be same in a layer within a block. i.e. within a block, the material can be different from one layer to the other layer, but can't be different from one zone to the other zone.

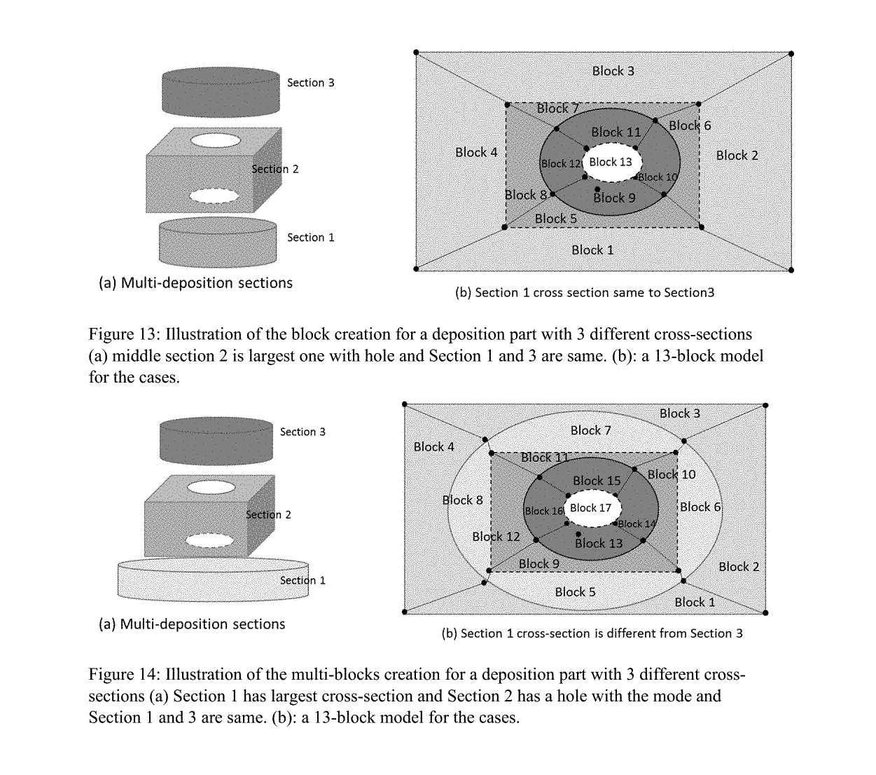

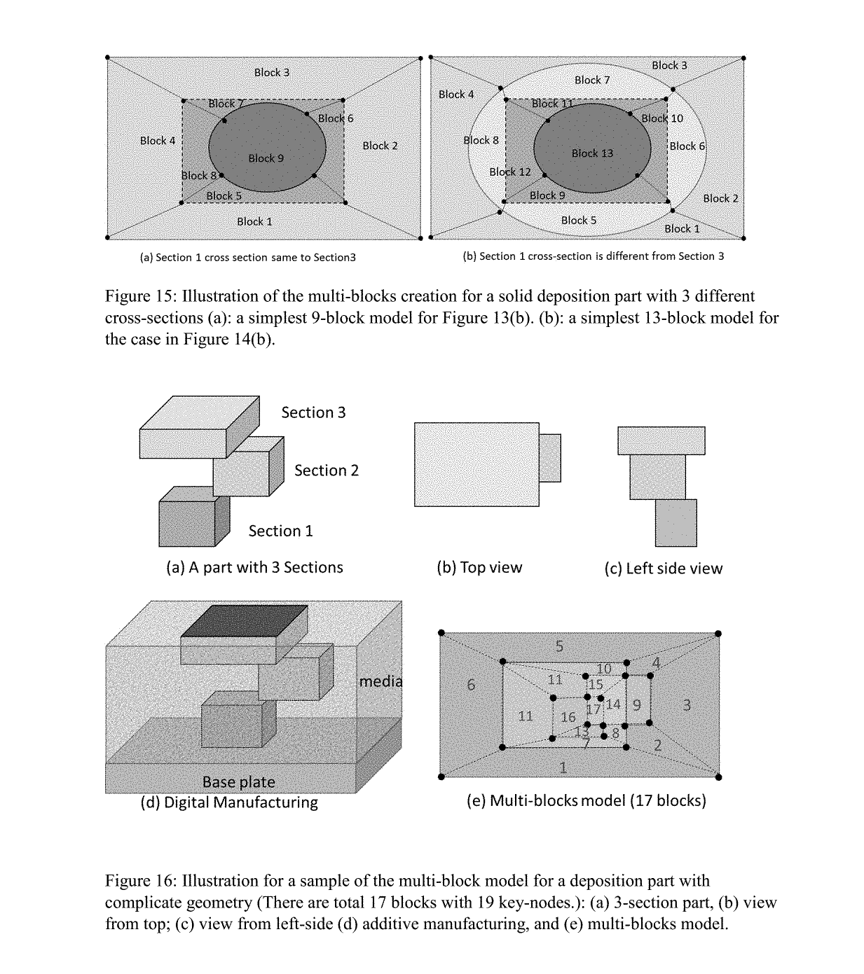

5. A method to create the multi-blocks for the deposition part with simple multi-different cross-sections from some layers to the other some layers over a regular base plate.
(i) The method is an extension of the claim 4 to create the multi-blocks for the deposition part with more than two different cross-sections from some layers to the other layers and follows the rule of block creation claimed in claim 2(vi).
(ii) Creating the multi-blocks for a deposition part with 3 different cross-sections and middle section smaller than the top and bottom section is shown in FIG. 12(a). While the Section 3 is same to the Section 1 both profile and location, a simplest 9-blocks model can be used to describe this model as shown in FIG. 12(b). If the Section 1's cross-section is larger than the Section 3, a simplest 13-blocks model can be utilized to emulate this case, as shown in FIG. 12(c). While the Section 1's cross-section is less than the Section 3, a simplest 13-blocks model can be established to model and analyze the case.
(iii) Creating the multi-blocks for a deposition part with 3 different cross-sections, and, the middle section with hole is larger than the top and bottom sections is shown in FIG. 13(a). A simplest 13-blocks model can be applied to this case as shown in FIG. 13(b).
(iv) Creating the multi-blocks for a deposition part with 3 different cross-sections and the Section1 has the largest section and the Section 3 has smallest section as shown in FIG. 14(a). A simplest 17-blocks model can be applied to this case for a quick simulation.
(v) From claim 5(iii) and claim 5(iv), while the Section 2 becomes solid, the FIG. 13(b) can be reduced to a 9-blocks model as shown in FIG. 15(a) and FIG. 14(b) will become a 13-block model to analyze the case as shown in FIG. 15(b).
(vi) The rule for creating a multi-blocks model for a deposition part with simple different cross-sections is still following the rule claimed in claim 2(vi), i.e. within a block, the material must be same in each individual layer.

6. A Method to create the multi-blocks model for a deposition part with much complicate structures over a regular baseplate.
(i) The method is an extension of claim (2) to claim (5) to create the multi-blocks model for the deposition part having more complicate cross-sections.
(ii) Creating the multi-blocks model for the deposition part with more complicate cross-sections is basically following the rule claimed in claim 2(vi). FIG. 16 shows a sample of multi-blocks model for a complicate deposition part which have 3 sections and partially overlap each other. It can be used a simplest 17-blocks model to model it as shown in FIG. 16(c).
(iii) Following the rule claimed in claim 2(vi), a deposition part with any complicate geometry can be divided into multi-blocks, and the total blocks number is dependent on the part shape complexity. But the more the blocks, the more the computation time.

7. A method to create the multi-blocks model for the multi-deposition parts with arbitrary profiles over a regular baseplate.
(i) The method is an extension of the claim (2) to claim (6) to create the multi-blocks model for multi-deposition parts with arbitrary profiles and more than two parts over a regular base-plate.
(ii) The rule of creating the multi-blocks model for multi-deposition parts with arbitrary profiles deposited over a regular base plate is still following the rule claimed in claim 2(vi). And, the less the total blocks, the less the computation work. Thus, the simplest multi-blocks model is always recommended to create the block model for any multi-deposition parts with arbitrary shapes over a regular base plate.

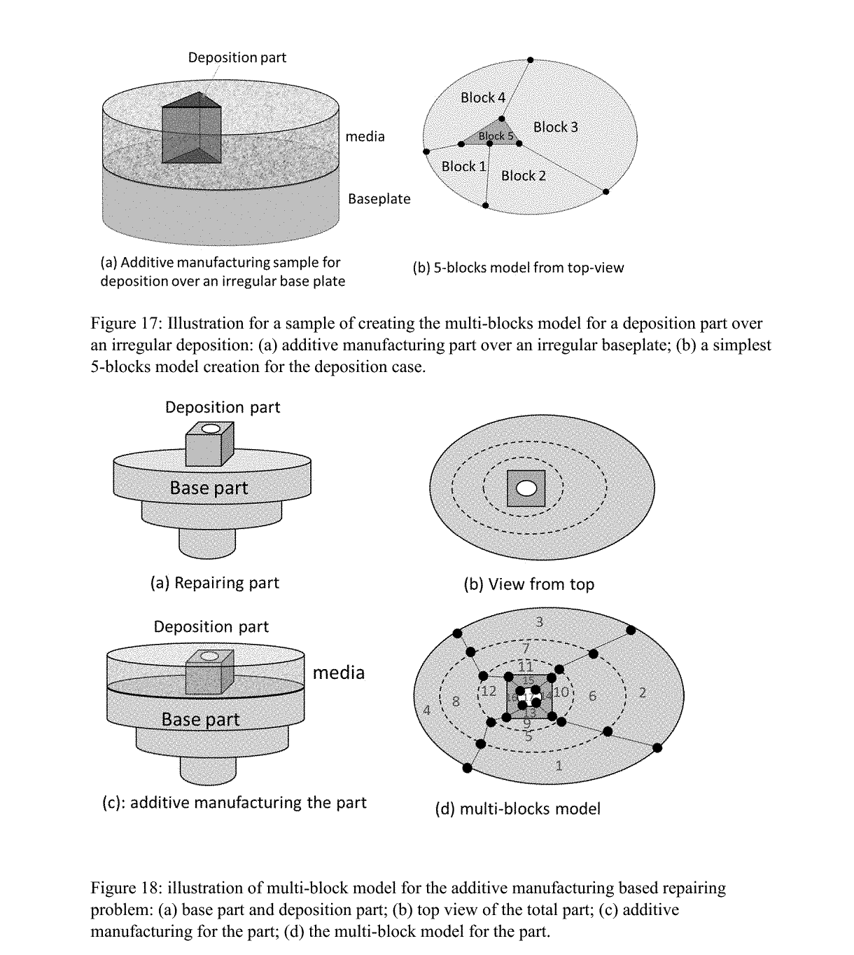

8. A method to create the multi-blocks model for the deposition part deposited over an irregular base plate.
(i) The method is an extension of all the above claims to create the multi-blocks model for the deposition part with an arbitrary profile/shape over an irregular base plate. FIG. 17 illustrates how to create the simplest 5-blocks for a triangle part deposition over an irregular baseplate. FIG. 17(a) shows a triangle part deposition over an irregular baseplate. A simple 5-blocks model can be created for computing such a type of deposition as shown in FIG. 17(b).
(ii) The method can be utilized for modeling and simulating the additive manufacturing based repairing since the host part can be treated as a baseplate with complicated geometry. FIG. 18 displays a sample of creating the multi-blocks model to compute the additive manufacturing of repairing part. As shown in FIG. 18, a simple 17-blocks can be utilized for simulating the effect of the processing parameters and deposition path/strategy on the temperature, temperature gradient and cooling rate in the whole additive manufacturing part.
(iii) The rule of the multi-blocks creation for the deposition part deposited over an irregular base plate follows the claim in claim 2(vi).

9. A method to create the multi-blocks model for the multi-deposition parts deposited over an irregular base plate.
(i) The method is an extension of all the above claims to create the multi-blocks model for the multi-deposition parts deposited over an irregular baseplate.
(ii) The method can be applied for modeling and simulating the additive manufacturing based repairing problem since the host part can be treated as a base plate with complicate geometry.
(iii) The rule of the multi-blocks creation for the multi-deposition parts deposited over an irregular base-plate follows the claim in claim 2(vi). And, the less the blocks, the less the computational works.

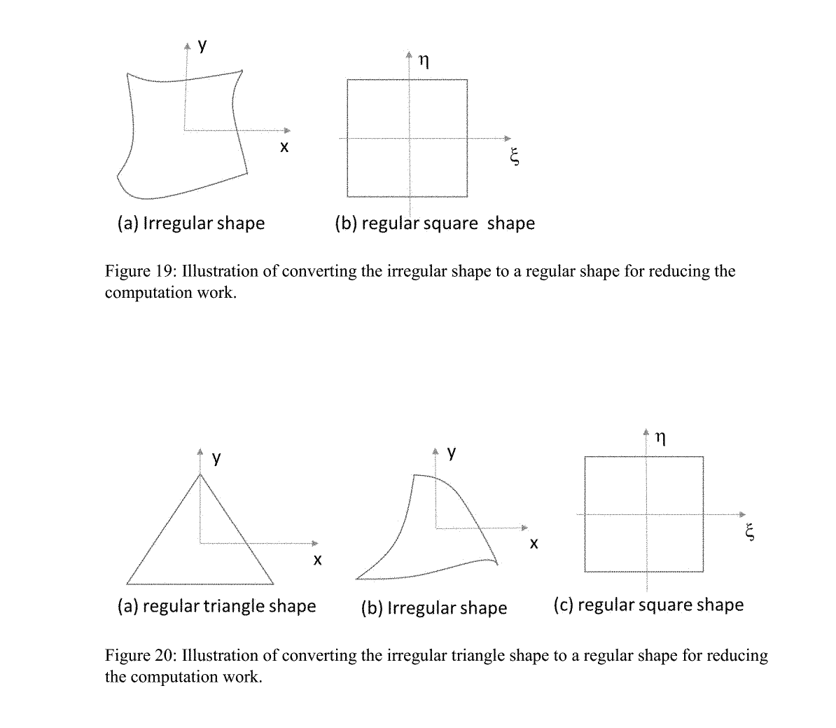

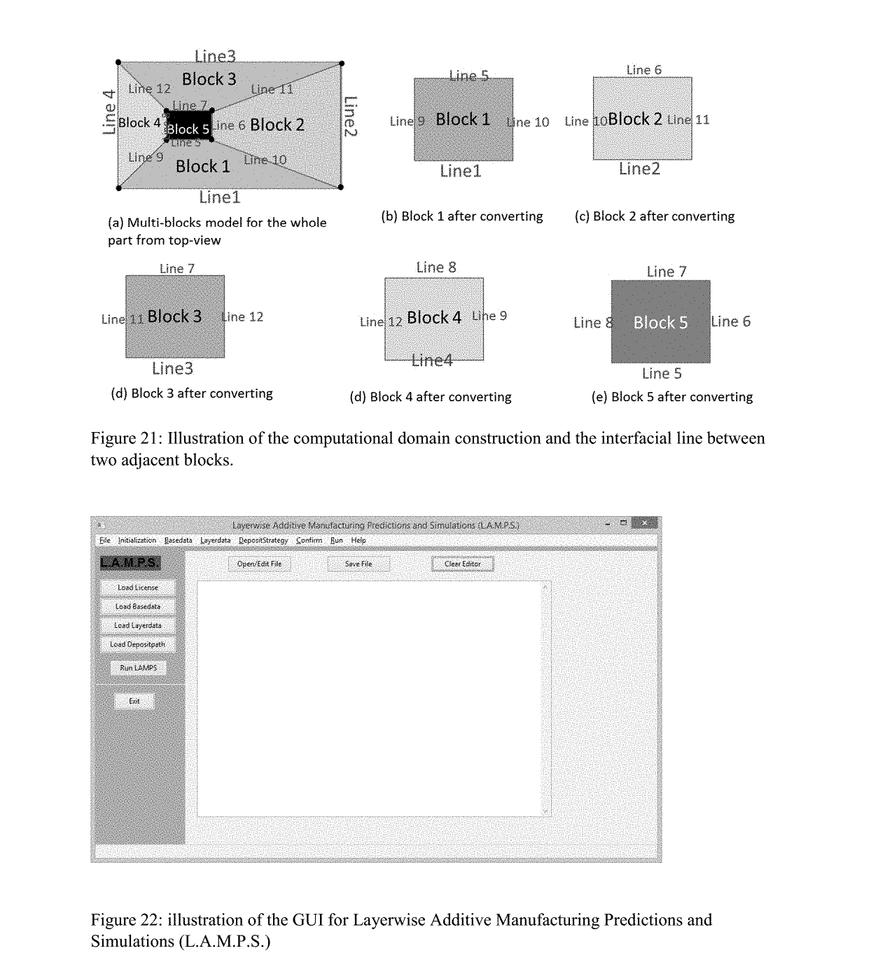

10. A method to reduce the simulation complexity and construct the computation domain by converting the irregular profile to a regular profile for each block.
(i) Converting any irregular block profile/shape to a regular profile/shape using the regular geometry transfer. FIG. 19 shows the profile converting from an irregular one to a regular one. FIG. 20 displays the triangle profile converting to a regular square shape. Appendix I shows some mathematic methods about how to convert the irregular shape to a regular one.
(ii) Constructing the whole computation domain by using the continuity conditions to connect two adjacent blocks for quick simulation. FIG. 21 displays the construction of the whole computation domain for the sample in FIG. 2(b). In order to conveniently construct the computation domain, the interfaces between the different blocks are marked by Lines. There are total 12 lines for the sample from Line 1 to Line 12. And, Line 1 to Line 4 are the natural boundary conditions. Line 5 to Line 12 are the sharing lines for two adjacent blocks and the relevant continuity conditions are presented in Equation (A2-8) based on the Fourier's law as shown in Appendix II about the general heat conducting problem.
(iii) The rule of constructing the whole computation domain, the continuity condition between two adjacent domains must be introduced based on the Fourier's law as shown in Equation (A2-8) in Appendix II.

11. A method to reduce the computation work for the deposition part with much complicate geometry
(i) The method is an extension of the above claims to reduce the computation work for the deposition part with much complicate geometry. To construct the computation domain for a deposition part with much complicate geometry, more blocks are required firstly to create the blocks model for the part and convert them to one regular shape as shown in FIG. 19(b) or FIG. 20(c). This means the interfacial line number will increase for the part.
(ii) The rule of constructing the whole computation domain is following the rule claimed in claim 10(iii), i.e., the continuity condition between two adjacent domains must be introduced based on the Fourier's law as shown in Equation (A2-8) in Appendix II.

12. A method to reduce the computation work for the multi-deposition parts with much complicate geometry
(i) The method is an extension of the above claims to construct the computation domain for the multi-deposition parts with much complicate geometries. Due to multi-deposition parts deposited over a baseplate, more blocks are required to create the multi-blocks model for the parts. Consequentially, more computation sub-domains are required to construct the whole computation domain for the multi-deposition parts. The rule for constructing the whole computation domain is following the rule claimed in the claim 11(ii).
(ii) Creating the continuity conditions for the multi-deposition parts with much complicate geometries is following the rule claimed in claim 10(iii).

13. A method to reduce the computation work for each block by simplifying the 3D problem to a 2D problem
(i) The method is an extension for the above multi-blocks model for additive manufacturing to reduce the computation work from a 3D problem to a 2D problem for each block. As above claimed, the material in a single layer must be same within a block but its property could be isotropic or anisotropic. This allows us to simplify the 3D problem for additive manufacturing to a 2D problem for each block on the basis of laminated block technique, see claim 13(ii). This will dramatically reduce the computational work for modelling the additive manufacturing procedure.
(ii) Simplifying the 3D problem of additive manufacturing to a 2D problem based on laminated block method to reduce the computation work in additive manufacturing. As is well-known, the laminated plate/shell theory has been widely applied to analyze the mechanical deformation and stress-strain distribution in a laminated composite material structure. Reference [1] about the laminated plate/shell theory has great presented how to derive the governing equations based on the variational principle and the different reasonable displacement assumption which can well describe the plate/shell's deformation, stress/strain layer by layer. Thus in a same manner, for heat transfer problem in a laminated block model for additive manufacturing, the various temperature field assumption in a layer can be applied to derive the governing equations for the laminated heat transfer problem. The temperature distribution through a layer thickness can be one of the first-order, second-order or higher-order field assumption. The higher-order temperature field assumption will be more accurate. Appendix III shows the variational principle for the heat transfer problem as well as the first-order (linear) and second-order (quadratic) temperature field assumption. After submitting the assumption of the temperature field and integrating the variables through the layer thickness, the 3D problem can be simplified into a 2D problem.
(iii) The laminated block approach can set a deposition layer as a layer to create the whole resultant properties, or, a deposition layer can be divided into multi-layers to create the whole block resultant properties for improving the accuracy, like a zip-zap model shown in Reference [1].

14. A method to solve the developed model to get the temperature, temperature gradient and cooling rate for additive manufacturing procedure
(i) The method is an extension of the above claims to solve the governing equations derived in claim 13 in terms of the different temperature field assumptions as shown in Appendix III.
(ii) Series expansion based solutions for spatial and temporal variables have be applied to solve the governing equation analytically, include the Fourier series and Lagrange series etc.

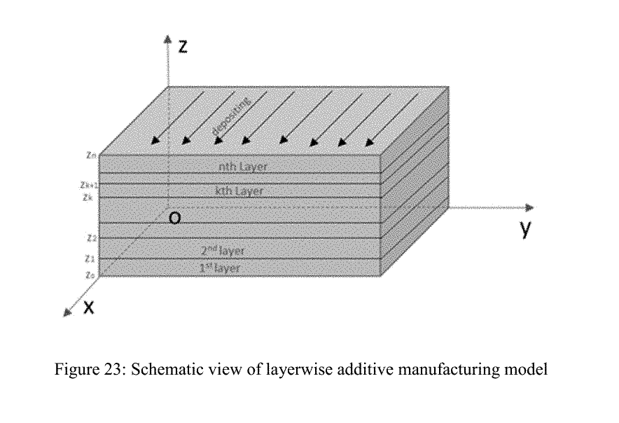

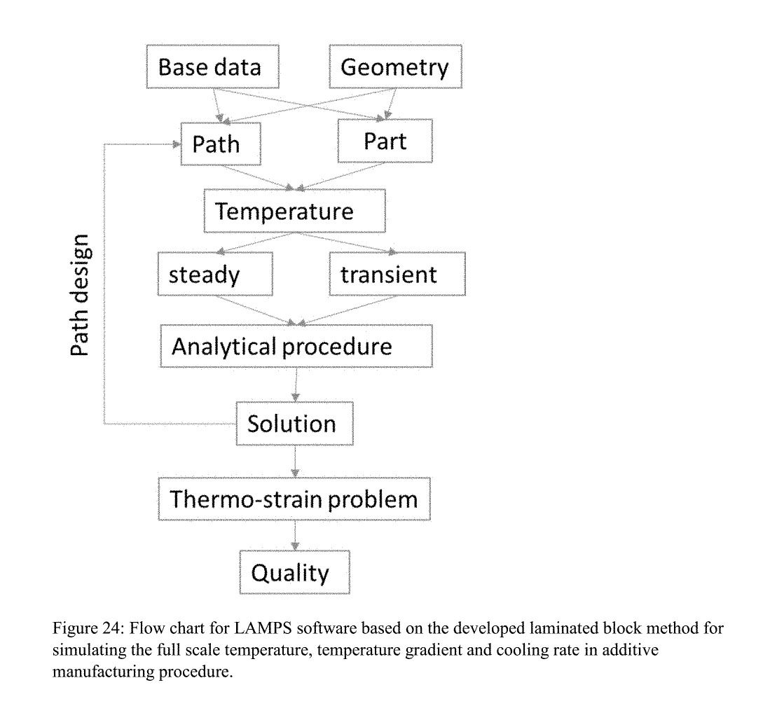

15. A method to implement the developed method for calculating the full-scale temperature, temperature gradient and cooling rate throughout the additive manufacturing procedure
(i) The method is an extension of the above claims to implement the developed model by C++ program language based on the variational principle of heat transfer problem with the layer-piecewise assumption of the temperature field as shown in Equations (A3-1) and (A3-2) in Appendix III.
(ii) Both Fourier series and Lagrange series based solutions have been implemented and utilized to validate the model and method. The software is called as Layerwise Additive Manufacturing Predictions and Simulations (L.A.M.P.S.). Its graphic user interface for LAMPS version 1.0 is shown in FIG. 22. The simulation is in a good agreement with commercial FEM results as well as the computational efficiency, as shown in Appendix IV.
(iii) The flow chart for the LAMPS simulation is as shown in FIG. 23.

16. A method to connect the deposition path/strategy with the developed layerwise multi-block method
(i) The method is to read the deposition path/strategy and convert them to the simulation language for simulating the temperature distribution, temperature gradient and cooling rate based on the processing parameters and path/strategy and above claimed laminated block method.
